(19) United States
(12) Patent Application Publication
(10) Pub. No.: US 2019/0316668 A1
(43) Pub. Date: Oct. 17, 2019

(54) ROLLER LIFTER AND METHOD OF MANUFACTURING THE SAME

(71) Applicant: OTICS CORPORATION, Nishio-shi (JP)

(72) Inventors: Satoshi SUZUKI, Nishio-shi (JP); Eiichi NOZAKI, Nishio-shi (JP); Akihiro SUZUKI, Nishio-shi (JP)

(73) Assignee: OTICS CORPORATION, Nishio-shi (JP)

(21) Appl. No.: 16/367,505

(22) Filed: Mar. 28, 2019

(30) Foreign Application Priority Data
Apr. 17, 2018 (JP) 2018-078835

(51) Int. Cl. F16H 53/06; F02M 59/10; F04B 9/04; B21D 28/26

(52) U.S. Cl. CPC F16H 53/06; F02M 59/102; F01L 1/14; B21D 28/26; F04B 9/042

(57) ABSTRACT

A roller lifter includes a lifter body having a cylindrical peripheral wall with a sliding surface on an outer periphery thereof and a roller rotatably mounted via a shaft member on the lifter body and brought into contact with a cam. The sliding surface is reciprocally slid in a sliding hole of a lifter guide. The peripheral wall has a thicker part in a part thereof in a circumferential direction. The thicker part is shaped such that a thickening part is annexed to an outer wall part formed continuously with a constant thickness in the circumferential direction. The thicker part is formed with a rotation stopper bulging outward. The rotation stopper enters a guide groove communicating with the sliding hole of the lifter guide.

### CROSS-REFERENCE TO RELATED APPLICATIONS

This application is based upon and claims the benefit of priority from the prior Japanese Patent Application No. 2018-78835 filed on Apr. 17, 2018, the entire contents of which are incorporated herein by reference.

### BACKGROUND OF THE INVENTION

The present invention relates to a roller lifter and a method of manufacturing the same.

Japanese Patent Application Publication No. 2013-147947 discloses a roller lifter including a lifter body provided to be reciprocally slidable with respect to a guide surface part of a lifter housing and a roller rotatably supported on the lifter body. The lifter body has a cylindrical outer peripheral part which is guided in a sliding direction by the guide surface part of the lifter housing and a pair of support parts which are formed to protrude downward from a lower end of the outer peripheral part of the lifter body and support a support shaft. The lifter body is formed with a rotation stopper protruding in a cantilever manner in the lower end of the outer peripheral part. The rotation stopper prevents the lifter body from being rotated relative to the lifter housing.

When such a rotation stopper protruding in the cantilever manner is formed as in the roller lifter of the above-described type, the number of steps in a process of forming the rotation stopper is increased. More specifically, process is required to include a step of forming a protrusion in the cantilever manner by cutting a part of a wall of a cylindrical member which is a base of the lifter body, and a step of bending the protrusion so that the protrusion protrudes radially outward with respect to the outer peripheral part of the lifter body. This results in an increase in the manufacturing costs.

### BRIEF SUMMARY OF THE INVENTION

The present invention was made in view of the foregoing circumstances and an object thereof is to provide a roller lifter and a method of manufacturing the same both of which can reliably prevent rotation of the lifter body while simplifying the manufacturing process.

A roller lifter in accordance with the invention includes a lifter body having a cylindrical peripheral wall with a sliding surface on an outer periphery thereof, the sliding surface being configured to reciprocally slide in a sliding hole of a lifter guide, and a roller rotatably mounted via a shaft member on the lifter body and brought into contact with a cam. The peripheral wall has a thicker part in a part thereof in a circumferential direction. The thicker part is shaped such that a thickening part is annexed to an outer wall part formed continuously with a constant thickness in the circumferential direction. The thicker part is formed with a rotation stopper bulging outward, the rotation stopper being configured to enter a guide groove communicating with the sliding hole of the lifter guide.

A method of manufacturing a roller lifter in accordance with the invention is a method of manufacturing the above roller lifter. In the method, the rotation stopper is formed by setting a receiving part on the outer peripheral surface of the peripheral wall and by pushing out a part of an inner peripheral surface of the peripheral wall to the receiving part side by a punching member for punch-pushing.

The roller lifter manufactured in the manufacturing method in accordance with the invention includes the rotation stopper which is configured to enter the guide groove of the lifter guide is formed by bulging a part of the peripheral wall outward. As a result, only a step of bulging the part of the peripheral wall outward needs to be performed in order to form the rotation stopper in the peripheral wall. This eliminates the need for execution of a step of cutting a part of the peripheral wall and a step of bending the part of the peripheral wall required to form a rotation stopper protruding in a cantilevered manner as in the prior art. In particular, since the rotation stopper is provided in the thicker part which is shaped such that the thickening part is annexed to the outer wall part formed continuously with the constant thickness in the circumferential direction, breakage such as crack is less likely to occur when the rotation stopper is formed to bulge outward. Consequently, rotation of the lifter body can be reliably prevented while simplifying the manufacturing process.

### BRIEF DESCRIPTION OF THE SEVERAL VIEWS OF THE DRAWINGS

A preferred embodiment of the present invention will hereinafter be described with reference to the accompanied drawings, in which:

FIG. 1 is a schematic sectional view exemplifying a part of a fuel supply system including the roller lifter of the embodiment of the present invention;

FIG. 2 is a schematic sectional view of the roller lifter;

FIG. 3 is a bottom view of the roller lifter;

FIG. 4 is a sectional view of a rotation stopper of the roller lifter as viewed from above;

FIGS. 5A to 5F are diagrammatic views for explaining a manufacturing process of the roller lifter of the embodiment;

FIGS. 6A to 6D are also diagrammatic views for explaining a manufacturing process of the roller lifter, to be continued from FIGS. 5E and 5F;

FIG. 7 is a diagrammatic view for explaining a receiving part used in the manufacturing process of the roller lifter; and

FIG. 8 is a diagrammatic view for explaining a forming process of the rotation stopper.

### DETAILED DESCRIPTION

### Embodiment

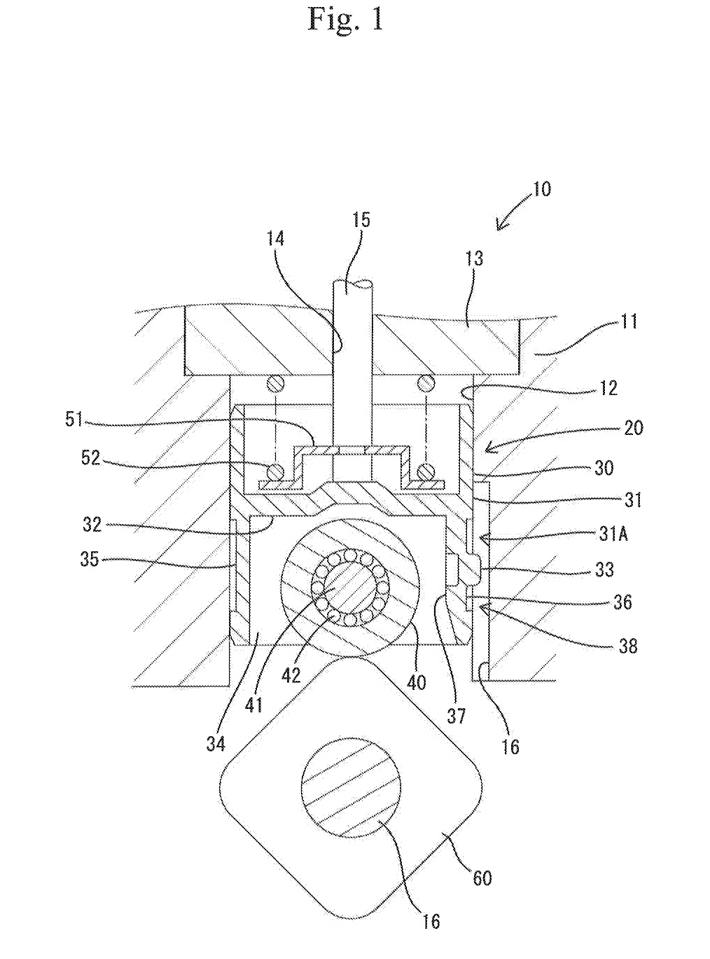

A roller lifter 20 of the embodiment will be described with reference to FIGS. 1 to 4. The roller lifter 20 is constructed, for example, as a pump lifter used in a fuel supply system 10 of an internal combustion engine as illustrated in FIG. 1. Although not illustrated in detail, the fuel supply system 10 is configured to supply fuel adjusted to a high pressure to a combustion chamber of an engine (not illustrated) by the roller lifter 20. The roller lifter 20 is incorporated in a lifter guide 11 of a cylinder head.

The lifter guide 11 is formed with a sliding hole 12 extending therethrough in an up-down direction and having a substantially circular section, as illustrated in FIG. 1. The roller lifter 20 is inserted in the sliding hole 12 so as to be reciprocally slidable in the up-down direction (in a reciprocating direction).

The sliding hole 12 has an upper end closed by a block 13. The block 13 is provided with a through hole 14 which extends therethrough in the up-down direction and has a circular section with a smaller diameter than the sliding hole 12, as illustrated in FIG. 1. A plunger 15 is inserted in the through hole 14 to be reciprocally slidable in the up-down direction. The plunger 15 has an upper end which is disposed to be movable into and out of a pressure chamber (not illustrated) which communicates with an upper end of the through hole 14. The upper end of the plunger 15 is moved into the pressure chamber whereby fuel in the pressure chamber is pressurized.

The lifter guide 11 is formed with a guide groove 16 extending in the up-down direction along the sliding hole 12. The guide groove 16 has a lower end opened downward. A rotation stopper 33 which will be described in detail later is located in the guide groove 16 so as to be movable in the up-down direction.

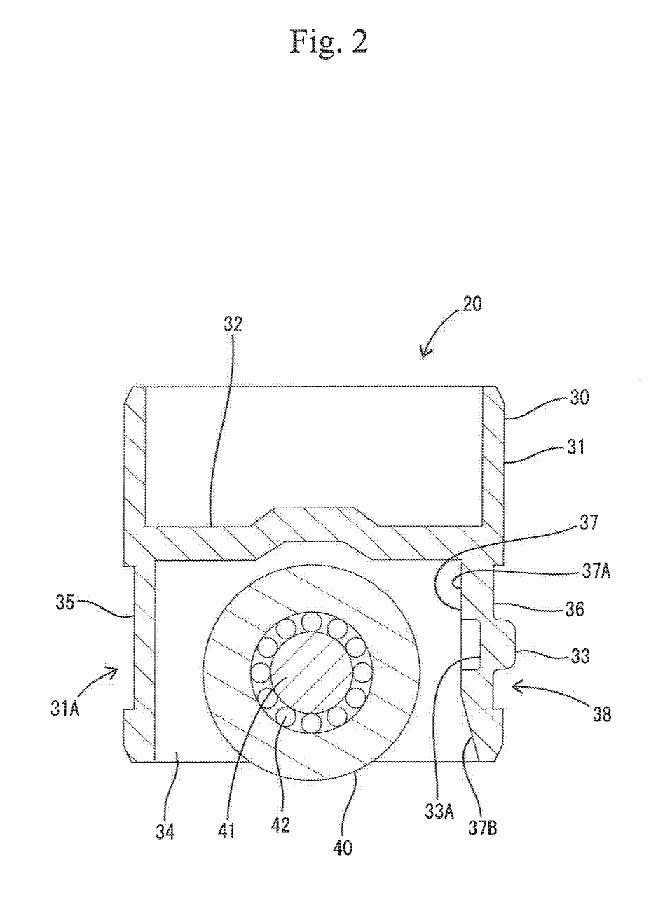

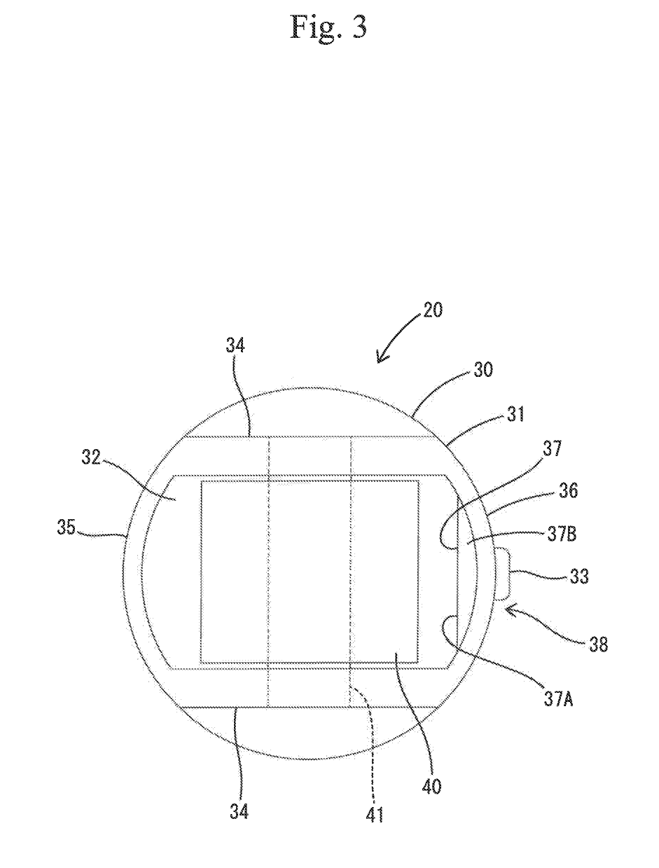

The roller lifter 20 includes a lifter body 30 and a roller 40 as illustrated in FIGS. 2 and 3. The lifter body 30 is configured to support the roller 40 and to reciprocate in the up-down direction according to rotation of a cam 60, as will be described later. The lifter body 30 includes a peripheral wall 31, a partition wall 32 and the rotation stopper 33. The peripheral wall 31 constitutes a shell of the lifter body 30 and is formed into a generally cylindrical shape extending substantially along the up-down direction. The peripheral wall 31 has an outer peripheral surface disposed along an inner peripheral surface of the sliding hole 12. The outer peripheral surface of the peripheral wall 31 includes upper and lower portions with a groove 31A to be described later being located therebetween. The upper and lower portions of the outer peripheral surface of the peripheral wall 31 are in sliding contact with the inner peripheral surface of the sliding hole 12. The peripheral wall 31 has the groove 31A formed by cutting a lower end side thereof along the outer peripheral surface, as illustrated in FIG. 2. The groove 31A formed in the peripheral wall 31 has an effect that a friction is reduced between the peripheral wall 31 and the sling hole 12 and an effect that a lubricating oil is easily stored in the groove 31A. The peripheral wall 31 has a pair of opposed walls 34, outer wall parts 35 and 36, and a thicker part 38, as illustrated in FIGS. 2 and 3.

The opposed walls 34 each constitute a part of the lower end side wall part of the peripheral wall 31. The opposed walls 34 are located between the outer wall parts 35 and 36 which are paired in the peripheral wall 31. The paired opposed walls 34 are provided to be opposed to each other approximately in a parallel manner as illustrated in FIG. 3. The opposed walls 34 are each formed into the shape of a substantially rectangular plate. Both ends of a shaft member 41 are supported by the opposed walls 34. As illustrated in FIG. 2, a cylindrical roller 40 is rotatably supported on the shaft member 41 via a needle bearing 42, for example.

The roller 40 is disposed such that an outer peripheral surface thereof is brought into contact with a cam 60. The cam 60 has a substantially quadrangular shape and is mounted on a cam shaft 61. The cam shaft 61 is rotatably supported on a pair of support walls (not illustrated) in a manner such that a rotation axis thereof is held at a fixed position. The shaft member 41 and the cam shaft 61 are arranged along a direction perpendicular to the direction of reciprocal movement of the lifter body 30 and arranged in parallel to each other.

The outer wall parts 35 and 36 each constitute a part of the lower end side wall part of the peripheral wall 31. The outer wall parts 35 and 36 are arranged to be opposed to each other in a direction perpendicular to an axial direction of the shaft member 41, as illustrated in FIG. 3. More specifically, the outer wall parts 35 and 36 are arranged in pairs at both radial sides in the peripheral wall 31. The outer wall parts 35 and 36 are each formed continuously along a circumferential direction of the peripheral wall 31 with a constant thickness. A thickening part 37 is annexed to an inner peripheral surface of the outer wall part 36. More specifically, the thickening part 37 is annexed to a circumferentially middle part (a part except for both circumferential ends) of the outer wall part 36. The thicker part 38 is constituted of a part (the circumferentially middle part) of the outer wall part 36 and the thickening part 37. The thicker part 38 is thicker than the outer wall part 35 and both circumferential ends of the outer wall part 36. The outer wall parts 35 and 36 have respective outer surfaces which are curved along the inner peripheral surface of the sliding hole 12 of the lifter guide 11. The outer wall part 35 has an inner surface which is also curved as the outer surface thereof. On the other hand, the outer wall part 36 has the thickening part 37 on the inner surface thereof, and an upper end side part of the inner surface of the thickening part 37 (which is a region opposed to the rotation stopper 33 to be described later and which will be referred to as an inner surface 37A) is a flat surface extending along a chordwise direction. More specifically, the inner surface 37A is a flat surface perpendicular to wall surfaces of the opposed walls 34. Furthermore, a lower end side part of the inner surface of the thickening part 37 (which will be referred to as an inner surface 37B) is outwardly inclined. The inner surface 37B is thus inclined so that the lifter body 30 can be rendered lighter in weight.

The partition wall 32 is formed into a flat plate shape extending along the radial direction inside the peripheral wall 31, as illustrated in FIG. 1. The partition wall 32 has an outer periphery connected integrally with the inner peripheral surface of the peripheral wall 31. Accordingly, the lifter body 30 has a structure divided into upper and lower sides by the partition wall 32. The roller 40 placed between the opposed walls 34 is housed below the partition wall 32 in the lifter body 30. The roller 40 has a lower end which is visible below the peripheral wall 31.

The lifter body 30 is extended in the up-down direction as long as possible within a range in which the lifter body 30 does not interfere with a rotation locus of the cam 60 located below. In other words, the sliding length of the peripheral wall 31 in the up-down direction is secured sufficiently long, and accordingly, the lifter body 30 is structured so as to be less likely to incline in the sliding hole 12.

A lower end of the plunger 15, a retainer 51 and a biasing member 52 are housed in the lifter body 30 above the partition wall 32. The retainer 51 is formed into a disc shape extending along the radial direction and has a central part with which the lower end of the plunger 15 is engaged to be fixed. The biasing member 52 is a spring member consisting of a compression coil spring. The biasing member 52 has a lower end supported in abutment against an upper surface of the retainer 51 and an upper end supported in abutment against the block 13, and is elastically extensible/contractable in the up-down direction. The biasing member 52 has a biasing force to bias the lifter body 30 to the cam 60 side so that the roller 40 is pressed against the cam 60.

The rotation stopper 33 enters the guide groove 16 of the lifter guide 11 thereby to function to prevent the rotation with respect to the lifter guide 11, as illustrated in FIG. 1. The rotation stopper 33 is shaped such that a part of the peripheral wall 31 (a part of the thicker part 38) is bulged outward as illustrated in FIG. 2. With this configuration, only a step of bulging the part of the peripheral wall 31 outward needs to be performed in a manufacturing process of the roller lifter 20 in order to form the rotation stopper 33 in the peripheral wall 31. This eliminates the need for execution of a step of cutting a part of the peripheral wall and a step of bending the part of the peripheral wall required to form a rotation stopper protruding in a cantilevered manner as in the prior art.

The rotation stopper 33 is provided in a substantially middle part of the outer wall part 36 in the up-down direction (a part not overlapping the inner surface 37B in the radial direction). The rotation stopper 33 is provided in the thicker part 38. The thickness of the rotation stopper 33 in a radial direction of the peripheral wall 31 (a bulging direction) is larger than that of the outer wall part 35 and that of the circumferential ends of the outer wall part 36. As a result, breakage such as crack is less likely to occur when the rotation stopper 33 is formed to bulge outward, with the result that rotation of the lifter body 30 can be reliably prevented. Furthermore, the thicker part 38 is made thicker than the outer wall part 35 in order to secure the thickness of the rotation stopper 33, with the result that the lifter body 30 can be rendered lighter in weight as compared with a case where an entire peripheral wall 31 is made thick. The thickness of the opposed walls 34 is larger than that of the outer wall parts 35 and 36. The thickness of the opposed walls 34 is equivalent to or larger than that of the thicker part 38, which is to secure the strength to support the shaft member 41.

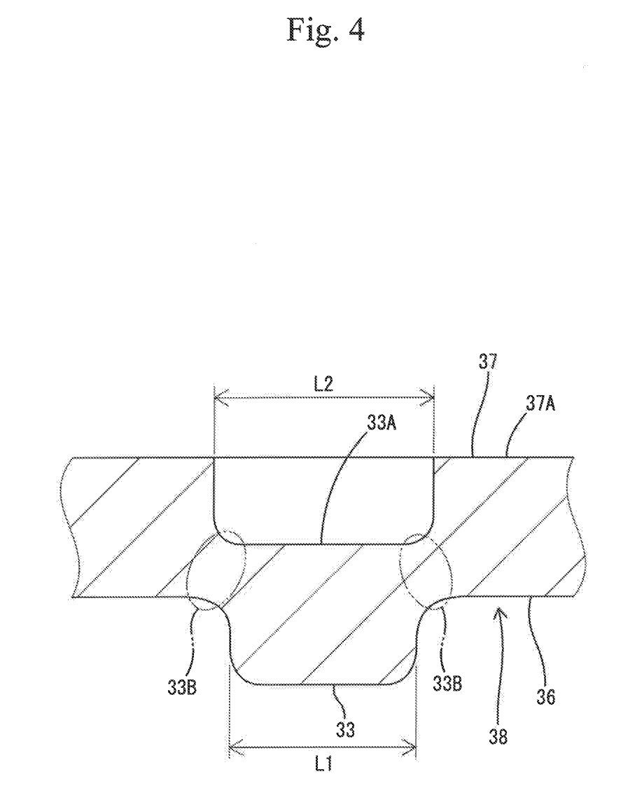

As illustrated in FIG. 4, the inner peripheral surface the peripheral wall 31 has a part corresponding to the rotation stopper 33 (a part r overlapping the rotation stopper 33 in the radial direction), and the part is formed with a punch pushed recess 33A. The punch pushed recess 33A is recessed radially outward with respect to the peripheral wall 31 so as to have a shape substantially identical with that of the rotation stopper 33. The rotation stopper 33 has a width L1 that is smaller than a width L2 of the punch pushed recess 33A in the circumferential direction of the peripheral wall 33 (more specifically, a direction parallel to the inner surface 37A). In other words, the rotation stopper 33 is formed such that compressive stress is generated (density is large) in boundaries 33B between the rotation stopper 33 and circumferentially adjacent portions. As a result, tensile stress is not easily generated in the boundaries 33B, so that breakage can be prevented from occurring in the boundaries 33B.

Furthermore, as compared with the configuration that the rotation stopper 33 has a larger width than the punch pushed recess 33A, a part of the peripheral wall 31 to be bulged is easily bulged with the surface of the part remaining in the original shape. Accordingly, tensile stress or the like is not easily generated on the surface side with the result that the surface roughness is less likely to be worsened. Still furthermore, since the inner surface 37A of the thickening part 37 is a flat surface extending along the chordwise direction, bulging work can be easily performed on the inner surface 37A as compared with a case where the inner surface 37A is a curved surface, with the result that the rotation stopper 33 can be easily formed.

Next, a manufacturing process of the roller lifter 20 will be described.

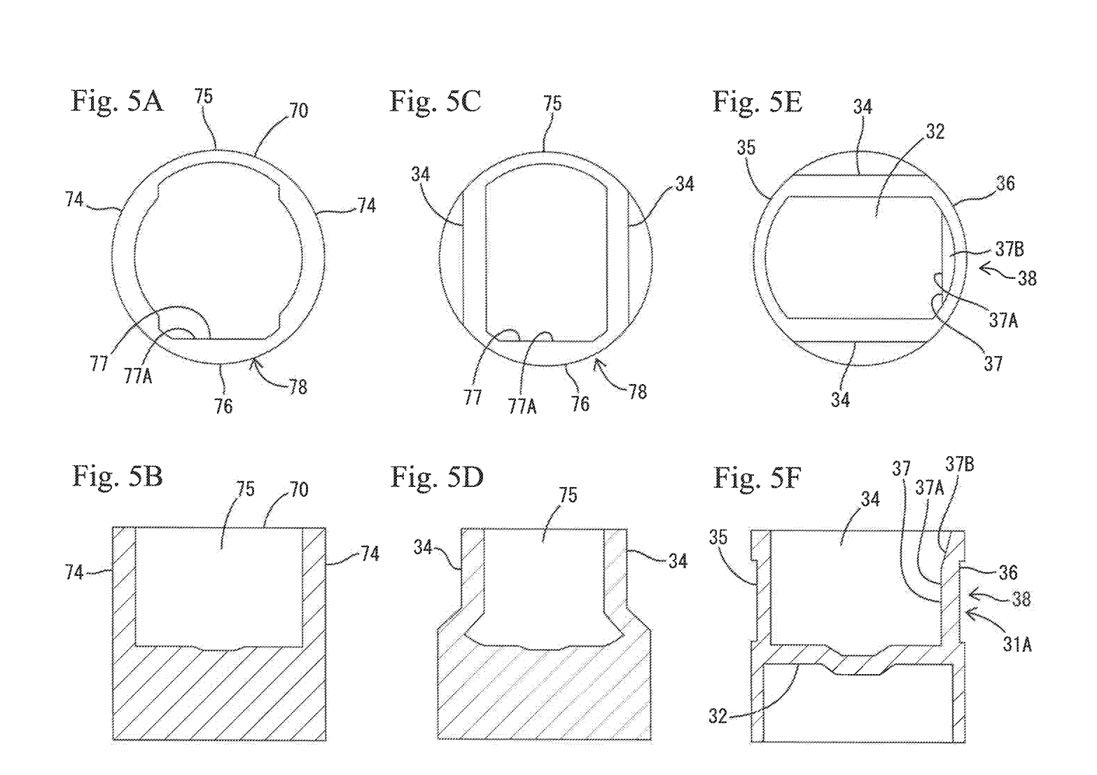

Firstly, cutting, pressing and the like are applied on a metal plate, and furthermore grinding and the like are applied on the outer surface, whereby a rough material 70 is formed, as illustrated in FIGS. 5A and 5B. The rough material 70 is formed into a cylindrical shape with one of two ends thereof being recessed. A wall part forming the recessed part is constituted of the pair of wall parts 74 and wall parts 75 and 76. The pair of wall parts 74 and the wall part 75 are each formed into an arc shape as viewed in a planar view. The wall parts 74 are each formed to have a larger thickness than the wall part 75. The wall part 76 has a thicker part 78 which is shaped such that a thickening part 77 is annexed to a part formed continuously with a constant thickness in the circumferential direction in the peripheral wall 31 and which has a larger thickness than both circumferential ends of the wall part 76 and the wall part 75. An inner surface 77A of the thickening part 77 is formed to be flat.

Subsequently, the rough material 70 is pressed in a manner such that the pair of wall parts 74 is pressed from the outside, whereby the pair of opposed walls 34 is formed, as illustrated in FIGS. 5C and 5D. The opposed walls 34 are each formed into a substantially rectangular shape and formed to be opposed to each other approximately in a parallel manner.

Subsequently, the member illustrated in FIGS. 5C and 5D is cut so that the partition wall 32, the groove 31A and the outer wall parts 35 and 36 are formed, as illustrated in FIGS. 5E and 5F. More specifically, an inner part of the other end side (the side opposed to the side where the opposed walls 34 and the wall parts 75 and 76 are formed) of the member illustrated in FIGS. 5C and 5D is cut so that the partition wall 32 is formed. The members illustrated in FIGS. 5E and 5F are shown with the respective members illustrated in FIGS. 5C and 5D being turned circumferentially 90°. The groove 31A is formed by cutting outer peripheral surfaces of the wall parts 75 and 76 along the circumferential direction. The end of the wall part 76 (an upper end as viewed in FIGS. 5C and 5D) is cut so that the thickening part 37 including the inner surfaces 37A and 37B is formed. The inner surface 37A is formed into a flat surface along the chordwise direction (a flat surface perpendicular to wall surfaces of the opposed walls 34). The inner surface 37B is formed as an inclined surface which is outwardly inclined. Thus, the outer wall parts 35 and 36 are formed as the result of formation of the groove 31A and the thickening part 37.

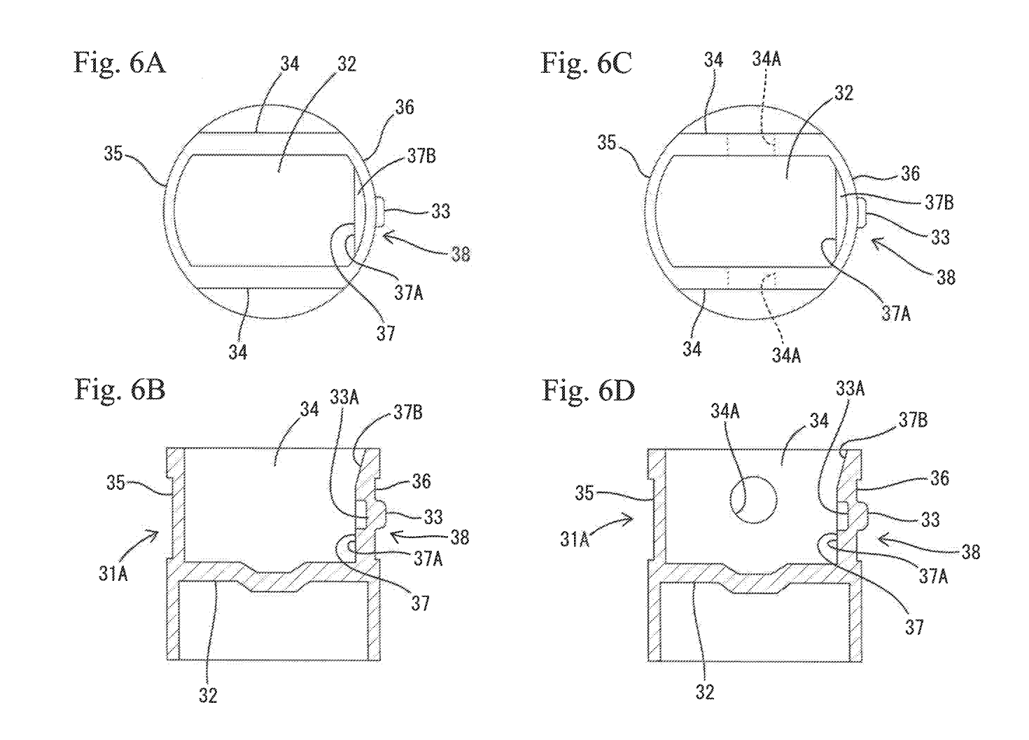

Subsequently, a receiving part 80 which will be described later is set on an outer peripheral surface of the peripheral wall 31 of the member illustrated in FIGS. 5E and 5F, and a part of the inner peripheral surface of the peripheral wall 31 is pushed out to the receiving part 80 side by a punching member 90 for punch-pushing, whereby the rotation stopper 33 is formed, as illustrated in FIGS. 6A and 6B. The punching member 90 is long in a pushing direction and has a pushing surface which is formed into a rectangular shape with rounded corners.

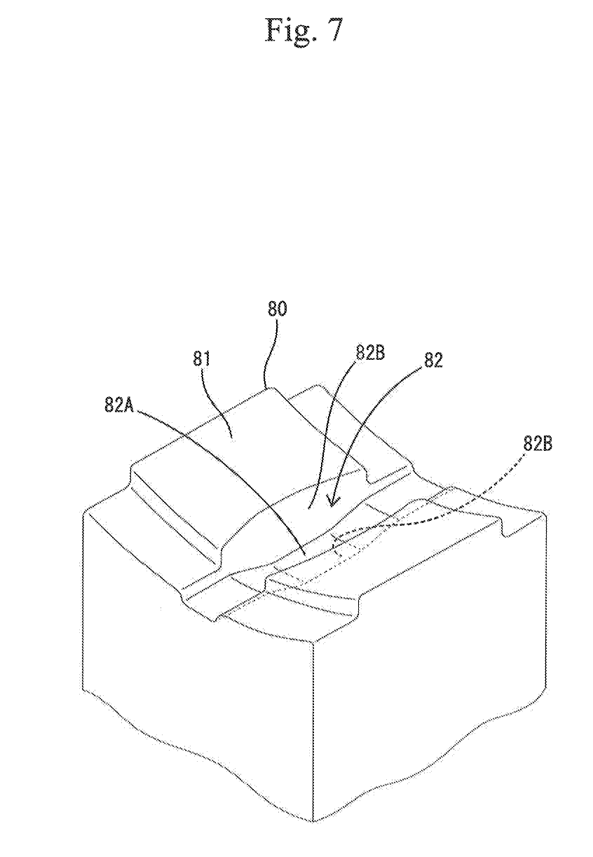

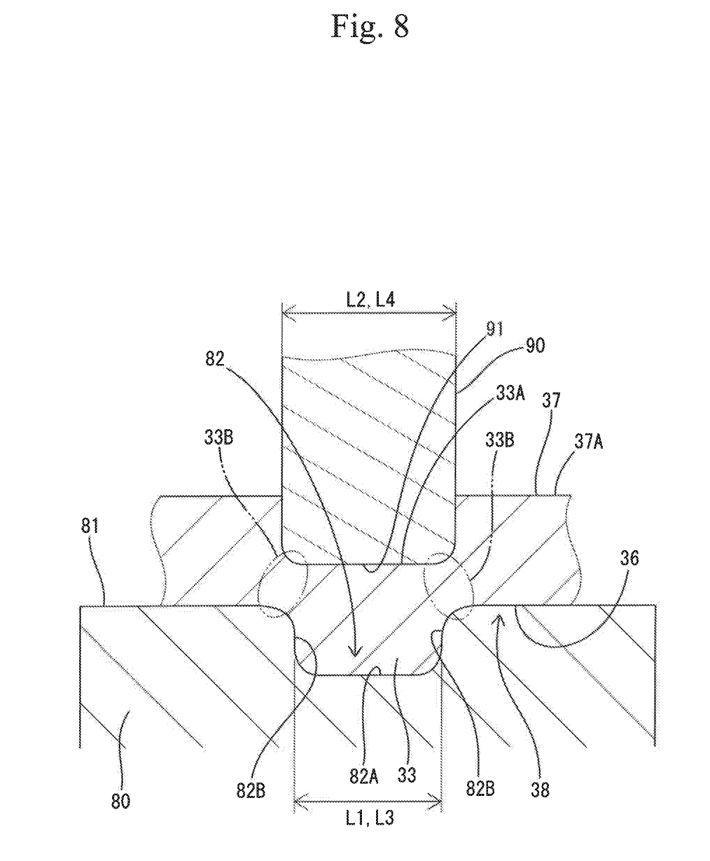

The receiving part 80 is constituted as a die having a support part 81 and a receiving-side recess 82 as illustrated in FIG. 7. The support part 81 is provided for supporting a workpiece during punch-pushing. The receiving-side recess 82 is recessed in a punch-pushing direction and has a bottom wall 82A and a pair of side walls 82B. The bottom wall 82A is formed into an elongated shape so as to divide the support part 81 and includes a longitudinal middle portion located slightly lower than the other portions thereof. The side walls 82B have respective surfaces parallel to the punch-pushing direction and are smoothly continued with the bottom wall 82A. The receiving-side recess 82 has two ends in a direction perpendicular to the direction in which the pair of side walls 82B are opposed to each other. The ends are open thereby to provide an escape for the material of the workpiece during the punch-pushing. According to this configuration, the receiving part 80 can be prevented from mold breakage caused by the material of the workpiece tightly confined in the receiving-side recess 82 during the punch-pushing, with the result that the manufacturability can be improved. As illustrated in FIG. 8, a width L3 of the receiving-side recess 82 (a distance between the pair of side walls 82B) is smaller than a width L4 of a pushing part 91 of the punching member 90 in the circumferential direction of the peripheral wall 31 (or more specifically, in a direction parallel to the inner surface 37A).

The receiving part 80 is then set such that the receiving-side recess 82 is opposed to an outer surface of the outer wall part 36, and a part of the inner surface of the outer wall part 36 is pushed out into the receiving-side recess 82 by the pushing part 91 of the punching member 90, whereby the rotation stopper 33 is formed as illustrated in FIGS. 6A and 6B. In this case, since the width L3 of the receiving-side recess 82 is smaller than the width L4 of the pushing part 91 of the punching member 90, the width L1 of the rotation stopper 33 is rendered smaller than the width L2 of the punch pushed recess 33A in the circumferential direction of the peripheral wall 31. As a result, the rotation stopper 33 is formed such that compressive stress is generated in the boundaries 33B between the rotation stopper 33 and circumferentially adjacent portions. Consequently, breakage is less likely to occur in the boundaries 33B.

Furthermore, as compared with the configuration that the width of the receiving-side recess 82 is larger than the width of the pushing part 91 of the punching member 90, the fluidity of the member to the bulging direction is rendered higher. Consequently, a part of the peripheral wall 31 to be bulged is easily bulged with the surface of the part remaining in the original shape, so that tensile stress or the like is not easily generated on the surface side with the result that the surface roughness is less likely to be worsened. Still furthermore, since the inner surface 37A of the thickening part 37 is a flat surface extending along the chordwise direction, bulging work can be easily performed on the inner surface 37A as compared with the case where the inner surface 37A is a curved surface, with the result that the rotation stopper 33 can be easily formed.

The rotation stopper 33 can thus be formed by execution of the step of pushing out a part of the inner peripheral surface of the peripheral wall 31 to the receiving part 80 side by the punching member 90. This eliminates the need for execution of a step of cutting a part of the peripheral wall and a step of bending the part of the peripheral wall required to form a rotation stopper protruding in the cantilevered manner as in the prior art. In particular, since the rotation stopper 33 is provided in the thicker part 38 which is shaped such that the thickening part 37 is annexed to the outer wall part 36 formed continuously with the constant thickness in the circumferential direction of the peripheral wall 31, breakage such as crack is less likely to occur when the rotation stopper 33 is formed to bulge outward. Consequently, rotation of the lifter body 30 can be reliably prevented while simplifying the manufacturing process.

Subsequently, the holes 34A are respectively formed to extend through the pair of opposed walls 34 in the direction in which the pair of opposed walls 34 are opposed to each other (the direction of the wall thickness), as illustrated in FIGS. 6C and 6D. The lifter body 30 is formed as described above. Both ends of the shaft member 41 (the shaft member 41 with the roller 40 being rotatably supported thereon via the needle bearing 42) are respectively inserted through the holes 34A and the shaft member 41 is supported on the pair of opposed walls 34 by swaging. The roller lifter 20 as shown in FIG. 2 is thus manufactured.

As described above, in the roller lifter 20 according to the embodiment, the rotation stopper 33 which enters the guide groove 16 of the lifter guide 11 is shaped such that a part of the peripheral wall 31 is bulged outward. Accordingly, only the step of bulging the part of the peripheral wall 31 outward needs to be performed in order to form the rotation stopper 33 in the peripheral wall 31. This eliminates the need for execution of a step of cutting a part of the peripheral wall 31 and a step of bending the part of the peripheral wall required to form a rotation stopper protruding in the cantilevered manner as in the prior art. In particular, since the rotation stopper 33 is provided in the thicker part 38 which is shaped such that the thickening part 37 is annexed to the outer wall part 36 formed continuously with the constant thickness in the circumferential direction of the peripheral wall 31, breakage such as crack is less likely to occur when the rotation stopper 33 is formed to bulge outward. Consequently, rotation of the lifter body 30 can be reliably prevented while simplifying the manufacturing process.

Furthermore, the peripheral wall 31 of the roller lifter 20 has the punch pushed recess 33A formed in a part of the inner peripheral surface thereof corresponding to the rotation stopper 33. The width L1 of the rotation stopper 33 is smaller than the width L2 of the punch pushed recess 33A in the circumferential direction of the peripheral wall 31. As a result, the rotation stopper 33 formed such that compressive stress is generated in the boundaries 33B between the rotation stopper 33 and circumferentially adjacent portions, so that breakage is less likely to occur in the boundaries 33B. Furthermore, as compared with the case where the width of the rotation stopper 33 is larger than the width of the punch pushed recess 33A, the part of the peripheral wall 31 to be bulged is easily bulged with the surface of the part remaining in the original shape, with the result that the surface roughness is less likely to be worsened.

Furthermore, the thickening part 37 is annexed to the inner periphery of the outer wall part 36 and has the flat surface extending along the chordwise direction. Consequently, bulging work can be easily performed as compared with the case where a part to be bulged is curved in the inner periphery in the circumferential direction, with the result that rotation stopper 33 can be easily formed.

In the method of manufacturing the roller lifter 20 in the embodiment, the rotation stopper 33 which is shaped such that a part of the peripheral wall 31 is bulged outward is formed by setting the receiving part 80 on the outer peripheral surface of the peripheral wall 31 and pushing a part of the inner peripheral surface of the peripheral wall 31 to the receiving part 80 side by the punching member 90. As a result, the rotation stopper 33 can be formed by execution of the step of pushing out a part of the inner periphery of the peripheral wall 31 to the receiving part 80 side by the punching member 90. This eliminates the need for execution of a step of cutting a part of the peripheral wall and a step of bending the part of the peripheral wall required to form a rotation stopper protruding in a cantilevered manner as in the prior art. In particular, since the rotation stopper 33 is provided in the thicker part 38 which is shaped such that the thickening part 38 is annexed to the outer wall part formed continuously with the constant thickness in the circumferential direction of the peripheral wall 31, breakage such as crack is less likely to occur when the rotation stopper 33 is formed to bulge outward. Consequently, rotation of the lifter body 30 can be reliably prevented while simplifying the manufacturing process.

The method of manufacturing the roller lifter 20 further includes the step of setting the receiving part 80 having the receiving-side recess 82 on the outer peripheral surface of the peripheral wall 31 and pushing out the part of the inner peripheral surface of the peripheral wall 31 to the receiving-side recess 82 by the pushing part 91 of the punching member 90. The width L3 of the receiving-side recess 82 is smaller than the width L4 of the pushing part 91 of the punching member 90. Consequently, since the rotation stopper 33 is formed such that compressive stress is generated in the boundaries 33B between the rotation stopper 33 and circumferentially adjacent portions, breakage is less likely to occur in the boundaries 33B. Furthermore, as compared with the configuration that the width of the receiving-side recess 82 is larger than the width of the punching member 90, the part of the peripheral wall 31 to be bulged is easily bulged with the surface of the part remaining in the original shape, with the result that the surface roughness is less likely to be worsened.

The rotation stopper 33 of the above-described roller lifter 20 is provided in the substantially middle part of the outer wall part 36 in the up-down direction. However, the rotation stopper 33 may be formed at another location. For example, the rotation stopper 33 may be formed at a location near the upper or lower end of the outer wall part 36 as long as the rotation stopper 33 does not radially overlap the inner surface 37B of the thickening part 37. Furthermore, the rotation stopper 33 may be formed to occupy a most part of the outer wall part 36 in the up-down direction as long as the rotation stopper 33 does not radially overlap the inner surface 37B.

Furthermore, the thickening part 37 may be annexed over an entire circumference of the inner periphery of the outer wall part 36.

Still furthermore, the thickening part 37 may be annexed to an outer periphery of the outer wall part 36.

Still furthermore, although the groove 31A is formed in the peripheral wall 31 in the foregoing embodiment, no groove 31A may be formed.

Still furthermore, the above-described roller lifter 20 may be configured as a roller tappet used in a valve mechanism of an internal combustion engine.

1. A roller lifter comprising:
a lifter body having a cylindrical peripheral wall with a sliding surface on an outer periphery thereof, the sliding surface being configured to reciprocally slide in a sliding hole of a lifter guide; and
a roller rotatably mounted via a shaft member on the lifter body and brought into contact with a cam,
wherein:
the peripheral wall has a thicker part in a part thereof in a circumferential direction;
the thicker part is shaped such that a thickening part is annexed to an outer wall part formed continuously with a constant thickness in the circumferential direction; and
the thicker part is formed with a rotation stopper bulging outward, the rotation stopper being configured to enter a guide groove communicating with the sliding hole of the lifter guide.

2. The roller lifter according to claim 1, wherein an inner peripheral surface of the thicker part includes a part corresponding to the rotation stopper, the part being formed with a punch pushed recess, and the rotation stopper has a smaller width than the punch pushed recess.

3. The roller lifter according to claim 1, wherein the thickening part is annexed to an inner periphery of the outer wall part and has a flat surface extending along a chordwise direction.

4. The roller lifter according to claim 1, wherein the thickening part is annexed to a circumferentially middle side of the outer wall part.

5. The roller lifter according to claim 1, wherein:
pair of the outer wall parts is provided on both radial sides of the peripheral wall;
the peripheral wall has a pair of opposed walls between the pair of the outer wall parts; and
the opposed walls have larger thicknesses than the outer wall parts.

6. A method of manufacturing the roller lifter specified in claim 1, wherein the rotation stopper is formed by setting a receiving part on the outer peripheral surface of the peripheral wall and by pushing out a part of an inner peripheral surface of the peripheral wall to the receiving part side by a punching member for punch-pushing.

7. The method according to claim 6, comprising a step of forming the rotation stopper setting the receiving part having a receiving-side recess on the outer peripheral surface of the peripheral wall and by pushing out the part of the inner peripheral surface of the peripheral wall into the receiving-side recess the pushing part of the punching member, wherein the receiving-side recess has a smaller width than the pushing part of the punching member.
